(19) United States
(12) Patent Application Publication
(10) Pub. No.: US 2009/0280252 A1
(43) Pub. Date: Nov. 12, 2009

(54) Method for Extending and Improving the Functionality of a Hard Surface

(76) Inventors: Andrew Armstrong, Houston, TX (US); C. Jim Armstrong, Houston, TX (US)

Correspondence Address: DARCELL WALKER, 8107 CARVEL LANE, HOUSTON, TX, 77036, US

(21) Appl. No.: 12/436,197

(22) Filed: May 6, 2009

Related U.S. Application Data
(60) Provisional application No. 61/050,860, filed on May 6, 2008.

(51) Int. Cl. B05D 3/10

(52) U.S. Cl. 427/299

(57) ABSTRACT

A method for cleaning hard surfaces at the micro level incorporates a two-phase process that initially cleans a surface and then seals the surface. The cleaning phase implements a cleaning solution that penetrates the surface of equipment and removes dirt and debris at the micro or nana level of the equipment. The sealing phase of the method seals the surface of equipment such that gaps at the micro level are filled in to prevent debris from accumulating at the micro-level of the surface of the equipment. The sealed surface provides improved aerodynamic flow of air across the hard surface.

### CROSS-REFERENCE TO RELATED APPLICATIONS

This application is related to and claims priority from provisional patent application No. 61/050,860 filed on May 6, 2008, the contents of which are incorporated herein by reference.

### FIELD OF THE INVENTION

The present invention is related to a method for cleaning hard services and in particular to a method for cleaning a hard surface at the micro level. A cleaning solution is used that is capable of penetrating a hard, non-porous surface and removing dirt and debris trapped at the micro level. The present invention further relates to a method that applies a sealing solution to the cleaned hard surface such that the sealing solution bonds with the hard surface and improves its aerodynamic efficiency.

### BACKGROUND OF THE INVENTION

In many industries, the cleaning of hard surfaces such as metal, painted metal, glass and tile is required on a regular basis. The reasons for the need to clean these hard surfaces range from improving the appearance of a product to improving the functionality of the product. For example, in some segments of the transportation industry, equipment with clean surfaces operates more efficiently then equipment with soiled surfaces. In particular, in the airline industry, an aircraft with clean surfaces is more aerodynamically efficient. Surfaces that are soiled create more friction and resistance (“drag”) as the aircraft moves through the air. The increased friction causes the aircraft to use/require more power (fuel) during operations. Increased fuel obviously has a dramatic effect on operating costs. Aircrafts with cleaner surfaces are more efficient.

The cleaning of a hard surface should extend beyond the superficial surface level to the micro-surface level. Even though a surface may appear to be clean and smooth, a micro-examination of a surface can reveal rough and uneven surfaces at the micro-level. The uneven micro-surfaces are usually the result of dirt and debris penetrating the surface, natural imperfections in the surface, and normal “wear and tear”. Continuous use of the equipment with soiled micro-surfaces can also contribute to inefficient operations of the equipment. In addition to inefficiency of operations of equipment, for some surfaces such as kitchen counters, debris at the micro surface level can work its' way up to the actual surface and create an unsanitary condition.

Cleaning of surfaces is a labor-intensive activity. Commonly, in cleaning such surfaces the maintenance personnel apply an aqueous cleaner composition to the surface either in a foamed or non-foamed form. Soil is then mechanically contacted with scrub brushes, cleaning towels and other cleaning implements. The soil and the cleaning materials are rinsed from the equipment surface with water or a rinse solution. The remaining rinse water is often removed by wiping, squeegee, or other processes in which the maintenance personnel remove remaining water spots. The last wiping/squeegee step is important to ensure that the hard surface dries to a shiny, bright, spot-free, streak-free and film-free appearance. Even though these cleaning methods are effective, these methods do not retrieve much of the debris at the micro-surface level. In installations or fleets having a high volume of assets/equipment, the square footage of hard surfaces requiring periodic cleaning requires a significant investment in time and labor. Any reduction in the time, labor, and materials used in hard surface maintenance will substantially improve operating efficiency and reduce costs.

Another concern about cleaning surfaces is the removal of the water and cleaning materials at the completion of the cleaning process. There have been attempts to address this concern. These attempts use modified silicones, hydrophobic mineral oils and other hydrophobic means to increase the tendency of aqueous materials to drain from a clean surface. Tests have shown that hydrophobic materials surprisingly increase surface energy and retain water as droplets of various sizes, rather than causing the water to sheet or drain freely. In using such hydrophobic materials, cleaning stations such as car washes tend to use forced air to coalesce and remove droplets or to remove water using chamois, squeegee or towel. Black, U.S. Pat. Nos. 5,536,452 and 5,587,022 teach a spray-on material used after showering that is formulated to maintain shower appearance. Such materials do not operate as a finish cleaner composition and simply are formulated to reduce the accumulation of new soil on a shower location. The compositions contain a specific surfactant and volatile cleaner materials to promote drying.

As mentioned, thorough cleaning of the surface of item can impact the operating costs of that item. Accordingly, a substantial need exists for improved cleaning compositions and methods that clean at the micro-surface level. In addition, a need exists for compositions that can be thoroughly removed from the surface of equipment after cleaning.

### SUMMARY OF THE INVENTION

The present invention provides a method for cleaning surfaces at the micro level. The method of the invention incorporates a two-phase process that initially cleans a surface and then seals the surface. The cleaning phase implements a cleaning solution that penetrates the surface of equipment and removes dirt and debris at the micro or nano level of the equipment. The sealing phase of the method of the present invention seals the surface of equipment such that gaps at the micro level are filled in, to prevent debris from accumulating at the micro-level of the surface of the equipment. The sealant also improves the aerodynamic flow across the surface of the equipment.

In the method of the invention, the cleaning agent is initially applied to the surface of a piece of equipment. The cleaning agent is one that has properties that enable it to penetrate the surface of the equipment, then break down and remove dirt and debris at the micro-level of the equipment. The cleaning agent comprises attributes of being non-abrasive and highly absorbent. In addition, the cleaning agent has penetrating attributes consistent with diatomaceous earth. The cleaning agent is given time to penetrate and breakdown dirt and debris at the micro level. The next step is to remove the cleaning agent from the equipment surface. After the removal of the cleaning agent, the sealing agent is applied to the surface of the equipment. The sealing agent has properties that enable it to cure and bond to the equipment surface. This bonding process fills in the uneven crevasses in the equipment surface. The filling in of the surface micro crevasses improves the aero-dynamics of the surface, as air flows across it. The final step would be to smooth the surface such as by buffing the surface and removing excess sealing agent from the equipment surface.

### DESCRIPTION OF THE DRAWINGS

FIG. 1 is a view of the surface of a piece of equipment seen by the human eye.

FIG. 2 is a view of the surface of a piece of equipment seen at the micro-level.

FIG. 3 is a view of the surface of a piece of equipment showing dirt and debris deposits at the micro-level.

FIG. 4 is a view of the surface of the piece of equipment shown in FIG. 3 after the removal of the dirt and debris deposits at the micro-level.

FIG. 5 is a view of the surface of a piece of equipment showing the flow of air over the surface of the equipment.

FIG. 6 is a micro view of the surface of a piece of equipment showing the flow of air over the surface of the equipment and showing interruptions in the air flow caused by the unevenness of the equipment surface at the micro-level.

FIG. 7 is a view of the equipment surface at the micro-level showing sealant penetrating into and filling the micro crevasses of the surface.

FIG. 8 is a view of the surface of the equipment at the micro-level with sealant filling the surface crevasses and improving the aero-dynamics of air over the equipment surface.

FIG. 9 is a flow diagram of the steps in the method of the present invention.

### DESCRIPTION OF THE INVENTION

The present invention provides a method for cleaning a surface at the microscopic (so small as to be invisible or indistinct without the use of the microscope) level. This invention is a two step process that extends asset life, while also reducing operating expenses, applies specific cleaning solutions using a two-step process, offers long lasting protection for any hard non-porous surface or coating applied to such surfaces.

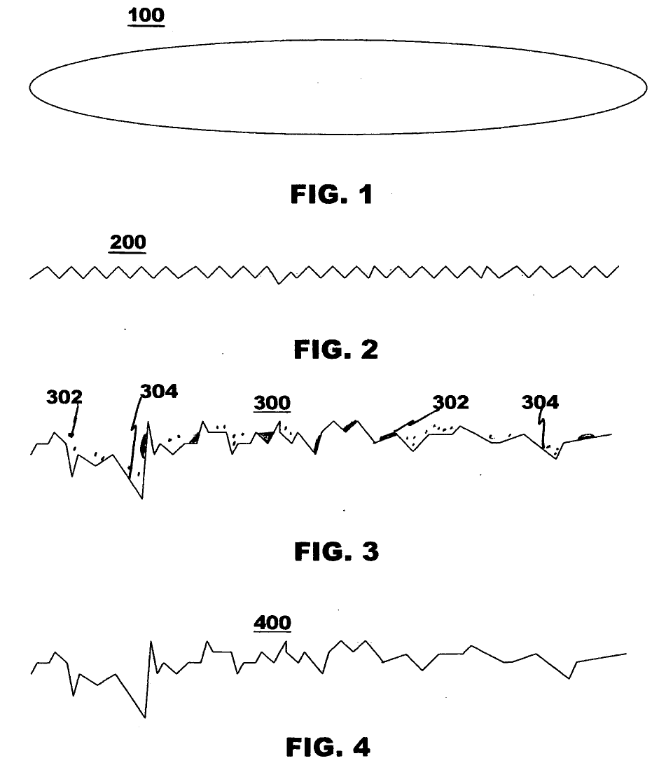

Referring to FIG. 1, shown is a typical hard surface of a piece of equipment. When seen at the eye level, the surface 100 appears smooth. This appearance is what a person sees and is usually satisfied with quality of the surface. FIG. 2 shows the equipment surface at the microscopic level. As seen the surface 200 is not the smooth looking surface as shown in FIG. 1. The uneven, rough and jagged surface provides many challenges for cleaning that type of surface. Dirt and debris deposits 302 accumulate and settle in the crevasses 304 of the surface 300.

As previously discussed, conventional equipment cleaning methods use force to penetrate and clean the surface. However, the use of force alone is usually not enough to adequately clean the equipment surface at the micro level. In the present invention, the cleaning solution such as Logisti-prep™ available at Logisticlean has the capability when applied to the surface of a piece of equipment, can penetrate the equipment surface down to the micro-level. This cleaning solution has the characteristics of being non-abrasive and highly absorbent, and is consistent with the known cleansing and penetrating attributes of diatomaceous earth.

Diatomaceous earth is a naturally occurring, soft, chalk-like sedimentary rock that is easily crumbled into a fine white to off-white powder. This powder has an abrasive feel, similar to pumice powder, and is very light, due to its high porosity. The typical chemical composition of diatomaceous earth is 86% silica, 5% sodium, 3% magnesium and 2% iron. Diatomaceous earth has many known applications, which include: filtration, abrasive, pest control, absorbent, thermal, hydroponics and DNA purification. The most common use (68%) of diatomaceous earth is as a filter medium, especially for swimming pools. It has a high porosity, because it is composed of microscopically small, coffin-like, hollow particles. The oldest use of diatomite is as a very mild abrasive and, for this purpose; it has been used both in toothpaste and in metal polishes, as well as in some facial scrubs. Diatomite is also used as an insecticide, due to its physico-sorptive properties. The fine powder absorbs lipids from the waxy outer layer of insects' exoskeletons, causing them to dehydrate. A disadvantages of using diatomaceous earth for pest control include the health risk to humans. The absorbent qualities of Diatomate make it useful for spill clean up and the U.S. Center for Disease Control recommends it to clean up toxic liquid spills. Diatomate's thermal properties enable it to be used as the barrier material in some fire resistant safes. Although there are numerous applications for Diatomaceous Earth has many applications in various products, however, none of the previously mentioned applications describe the application of Diatomaceous Earth in the present invention as a micro-level cleaning agent of a hard surface.

Referring again to FIG. 1, the cleaning solution can penetrate the surface to the micro-level (10 by 10 nanometer segment) and breakdown dirt and debris 302. Once the cleaning solution has had an opportunity to work it is removed taking with it the broken down dirt and debris that was deposited at the micro-level of the equipment surface. FIG. 4 shows the equipment surface 400 of FIG. 3 at the micro level after the removal of the debris.

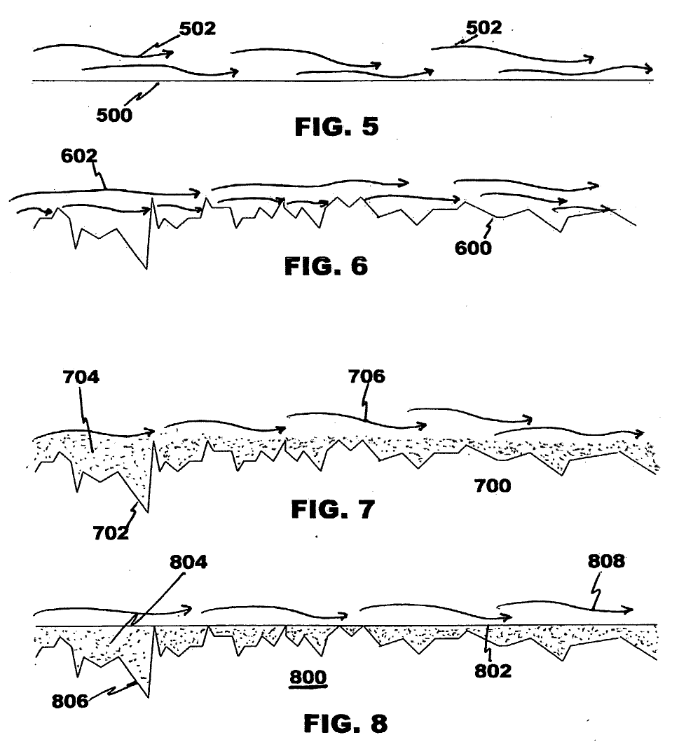

Although the surface is clean at the micro level, the second challenge is to address the aero-dynamics problem created by the uneven, rough, and jagged surface of the equipment. FIG. 5 shows the smooth appearance of the equipment surface 500 to the human eye. As the equipment moves through the air, air 502 flows over the smooth surface with little difficulty. However, when viewing the equipment surface at the micro level shown in FIG. 6, the rough, even and jagged surface 600 blocks air 602 as it flows over the surface. The blocking of the moving air increases the resistance for the equipment. The increased resistance increases the energy required to move the equipment through the air. In the present invention, the sealing solution fills in the crevasses 702 in the equipment surface 700. Referring to FIG. 7, the sealing solution 704 fills in these crevasses 702 and makes the equipment surface 700 aerodynamically less resistant to the moving air 706. The sealing solution such as Logisti-sealm available from Logisticlean forms a bond with the equipment surface material consistent with the characteristics of molecules in the acrylic polymer family. FIG. 8 shows the equipment surface 800 with a smooth surface 802. This surface is smooth from both normal eye level and the micro level. In this surface, the bonding material 804 fills in the crevasses 806 and prevents the blocking of the air 808 as it passes over the equipment surface. The air passes over the equipment more efficiently and requires less energy because there is substantially less resistance to the moving air from an uneven, rough and jagged surface blocking the air at the micro level.

This invention incorporates a cleaning solution and a sealing solution. The sealing solution bonds with the equipment surface at a microscopic level, to smooth, protect, and enhance the surface, while improving operating efficiency and reducing the operating and maintenance costs for that surface over the 3 to 5 year life of the product. The cleaning solution, such as Logisti-Prep™ provided by Logisticlean, penetrates the surface of the equipment down to the microscopic level and removes dirt and debris at that level. The second step of the process is the application of the sealing solution. A solution such as Logisti-Seal™ also manufactured by Logisticlean sealing the equipment surface after the surface has been cleaned using the cleaning solution.

As mentioned, the method of the present invention, involves the use of two environmentally safe chemicals solutions such as: Logisti-Prep™ that cleans a surface and Logisti-Seal™ that seals the surface. As mentioned, Logisticlean manufactures both mentioned chemicals. The prepping solution is used on any aged surface, which is defined as any surface over one month of age or one month past a reoccurring recoating, such as painting. For any fresh surface or freshly recoated surface, the sealing solution can be applied without first using the prepping solution.

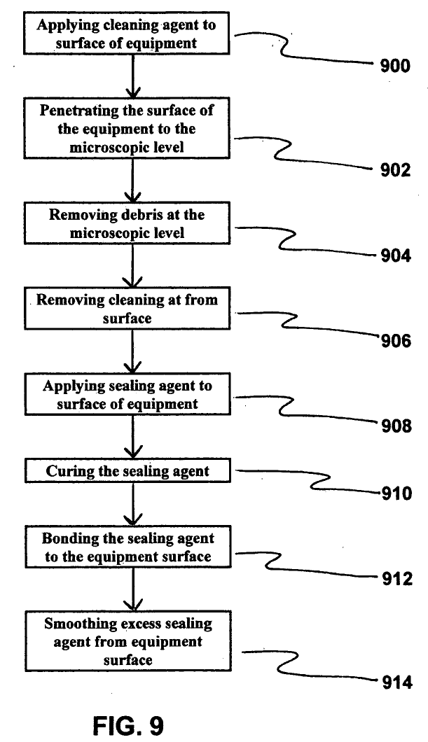

In the method of the invention shown in FIG. 9, step 900 applies the prep solution to the equipment surface to clean the surface of oxidation, dirt, grime, and other foreign debris. There are three methods of application: 1) by hand using a clean, cotton towel, 2) application by orbital buffer using a clean, cotton bonnet, or 3) application by drum buffer with a clean, cotton bonnet. After the Prep solution is applied to the surface, in step 902, the solution penetrates the equipment surface to the microscopic level. After penetrating to the microscopic level, in step 904, the solution loosens and removes debris from the microscopic level.

The solution as mentioned contains Diatemaceous earth. This substance contains micro particles that are small enough to penetrate the microscopic crevasses of a hard surface. Referring to FIG. 7, micro particles can drop to crevasses 702. The micro size of the particles does not inhibited from them sinking into the crevasses by size. Other abrasive solutions contain particles that are too large to penetrate to the microscopic level of the surface. As one can visualize from FIG. 7, larger sized particles not reach the dirt and debris in the crevasses.

Once the Prep solution particles penetrate to the microscopic level of the hard surface, it can contact the dirt and debris trapped in the surface. The highly absorption properties of the solution, then draws the dirt and debris away from the surface. This absorption loosens the dirt making it removable. The Prep is allowed to cure for 45 seconds to 5 minutes. As mentioned, Diatomaceous earth can have an abrasive property, this abrasive property is not relied upon in the present invention. Many substances with abrasive properties contain granules that penetrate and loosen dirty and debris. As previously described, the penetration of these granules is the result of the microscopic size of the granules and not necessarily the result of force being applied to the substance. In the present invention, regardless of the method of application, the Prep is allowed a time period to cure or penetrate the surface down to the micro-level. After approximately 45 seconds to 5 minutes of curing time, step 906 removes the prep solution. Various methods can be used to remove the prep solution such as by: 1) hand using a clean, cotton towel, 2) orbital buffer using a clean, cotton bonnet, or 3) drum buffer with a clean, cotton bonnet. This process leaves the surface clean and ready for the application of sealing solution. However, in the present invention the application and removal of the Prep solution can be done using a cotton bonnet material. The cotton material containing the Prep solution is applies to the surface. Once placed on the surface, the Prep solution begins to penetrate the surface as described. At the time of removal, the bonnet is removed from the surface. Because of the penetrating and absorbing character of the Prep, a more absorbent cotton material can draw the micro particles of the Prep solution that have traveled to the micro crevasses of the surface. The micro particles are removed taking the absorbed and loosen dirt and debris from the micro levels of the surface. In an alternate embodiment, there can be multiple applications of the Prep solution in order to more thoroughly clean the microscopic level of the surface.

In step 908, the sealing solution is applied to the surface using methods similar to those used to apply the prep solution. The sealing solution is applied and allowed to set for 45 seconds to 5 minutes in step 910 and forms a seal over the equipment surface. The sealant material can contain a small amount of the Diatemaceous earth material. The sealant also contains microscopic particles that penetrate the surface down to the microscopic level. Once at the microscopic level, the sealant, which contains an acrylic and can contain a Teflon substance bonds with the surface. Once curing has occurred, the seal is smoothed in step 912 and the excess sealant removed using the same application methods as defined above. As part of the activity occurring in the curing and bonding steps, the sealant solution penetrates the surface to the micro level and fills in and occupies the area where there was dirt and debris. The sealing agent forms a bond with the surface at the micro level. Upon the final removal and smoothing of the seal, the asset is ready to be placed in service immediately. In step 914, sunlight or other forms of heat will continue to strengthen the molecular bond between sealant and the equipment surface. At the completion of the process any cotton rags and bonnets can be safely washed after application using a commercial washer and dryer and be reused for future applications.

### Benefits of the Invention

The impact of the present invention on the bottom line of any company can be seen through the varied benefits proven to occur with application. The foremost benefit is the extension of asset life; as it offers protection from harsh chemicals, corrosion, erosion, environmental fallout, micro-abrasions, and other factors leading to costly recoating or replacement of assets. The smooth finish achieved with the application of Logisti-Seal also allows for an increased ease of clean using less water and no harsh chemicals. By filling in the pores of a surface, sealant of the present invention has a higher resistance to adherence of foreign debris; reducing the frequency, time, and cost associated with cleaning. Assets thus maintain a much better appearance, as the surface lasts longer and stays cleaner.

Another benefit achieved from the application of the present invention is the reduction of drag achieved by reducing the roughness heights associated with any surface. Reduction of fuel burning for both ground and aviation assets has been shown in both laboratory and operational testing.

As stated, the sealant in the present invention can be applied to any hard, non-porous surface with or without another coating in place. Uses for the product are virtually limitless, as it has been used in the aviation, ground freight, marine, oil and gas, municipal properties and assets, and other various fixed structures. All the benefits of the present invention have been proven through third party operational and laboratory testing. An environmentally safe chemical, process, the present invention eliminates the need for harsh cleaning chemicals and the dangers they pose, as well as reducing water for cleaning; while also reducing, if not eliminating, the need for repainting of assets.

### Accelerated Weathering Durability Testing

Applicant performed Accelerated Weathering Tests to ASTM and MIL standards to quantify the improved appearance, protection, and durability associated with the present invention. Painted and polished aluminum panels, both sealed and unsealed, underwent accelerated weathering for 2,000 hours, accelerated corrosion for 2,000 hours, and immersion and corrosion for 668 hours to measure the protective properties of the sealing process of the present invention. Panels were inspected visually to ASTM standards for corrosion, blistering, staining, cracking, and rusting. Instrumentation was used to measure gloss, distinctness of image, and color. The measurements by instrumentation in these three areas precluded the element of human bias and allow for a precise measurement on a standard scale to which a number of statistical comparative analyses can be done.

Though a direct correlation between accelerated weathering exposure hours and direct outdoor exposure was not made due to the inherent variability and complexity of outdoor exposure, it was believed that the QUV (Accelerated Weathering Tester) could reproduce damage that might occur over months or years. Deterioration includes gloss loss, cracking, crazing, hazing, strength loss, embrittlement, yellowing, and color change.” By testing to the 2,000-hour mark, the test panels were in the Accelerated Weathering Tester for in excess of three months in an effort to subject the product to the most extreme conditions possible. The ASTM standard of salt spray immersion required 168 hours, but was extended to 668 hours, while the accelerated corrosion was extended from 1,000 to 2,000 hours; again to test to the most extreme conditions possible.

Although weathering data is comparative data, one can still can get excellent durability data from accelerated weathering tests. The data generated by such tests is comparative data, not absolute data.

### Test Panels

All test panels were Aluminum 2024 clad T-3 measuring 3 inches by 6 inches with a thickness of 0.020 inches. Panels were either painted or polished for testing purposes. In each test there were a corresponding number of painted or polished panels with and without Logisti-Seal in order to establish scientifically comparable data.

Painted test panels had Akzo Nobel Primer and Topcoat BAC707 paint which is used on commercial airlines worldwide. Panels were independently painted. Some tested panels were polished using Polish XMA by Eldorado Chemical. The polish was applied in accordance with commercial airline procedures used for polishing aircraft for appearance and corrosion control.

Both painted and polished panels received the sealing agent after completion of either the painting or polishing. The agent “Logisti-Seal” was applied using the prescribed application method of the present invention. All panels were shipped to Q-Lab with a control code on the back identifying the process each had received. Q-Lab confirmed that all panels were received in good condition prior to the test commencement.

### Testing Parameters—All Tests

Accelerated Weathering testing was performed on 12 test panels. There were 3 painted, non-Logisti-Sealed panels, 3 painted, Logisti-Sealed panels, 3 polished, non-Logisti-Sealed panels, and 3 polished Logisti-Sealed panels. The panels were tested according to MIL-PRF-85285D specifications for 2,000 hours in a Q-Sun Xenon Test Chamber, model Xe-3HS. The ultraviolet light is provided by a Xenon Arc light with an ultraviolet light of 0.35 W/m2 @340 nm. The relative humidity during testing was 50% and the temperature was either 63 degrees Celsius (144 degrees Fahrenheit) or 42 degrees Celsius (108 degrees Fahrenheit) depending on cycle. The cycle was 102 minutes of light followed by 18 minutes of light plus spray for moisture. Testing for these panels consisted of Gloss readings, Distinctness of Image, and Instrumental Color readings. Readings were taken at 500, 1,000, 1,500, and 2,000 hours.

Accelerated corrosion testing was performed on 8 test panels. There were 2 painted, non-Logisti-Sealed panels, 2 painted, Logisti-Sealed panels, 2 polished, non-Logisti-Sealed panels, and 2 polished Logisti-Sealed panels. The panels were tested according to ASTM B117 using a Q-Fog Chamber, model SSP-1100 for 2,000 hours. The panels were scribed prior to exposure and subjected to a continuous fog of 5% NaCl (salt) solution at 35 degrees Celsius (95 degrees Fahrenheit). Visual inspections were taken every 250 hours for corrosion, blistering, staining, cracking, and rusting. A final corrosion evaluation including scraping and cleaning the scribe lines and taking corrosion measurements was completed after 2,000 hours. Originally testing was planned for 1,000 hours; however after completion of the first 1,000 hours testing was extended another 1,000 hours.

Immersion Testing was performed on 12 test panels. There were 3 painted, non-Logisti-Sealed panels, 3 painted, Logisti-Sealed panels, 3 polished, non-Logisti-Sealed panels, and 3 polished Logisti-Sealed panels. The panels were tested according to ASTM D870 using an Immersion Chamber. The panels were continuously immersed in deionized water for 668 hours at 38 degrees Celsius (100 degrees Fahrenheit). Panels were evaluated at the 168-hour (ASTM standard time) and 668 hour mark for blistering, peeling, and other signs of degradation.

### Testing Results

After 2,000 hours of exposure to Accelerated Weathering conditions, Logisti-Seal panels outperformed their non-sealed counterparts in every category. They retained 40% more of their original color, showed 44% more gloss, and maintained a 51% higher distinctness of image than the panels without Logisti-Seal. Logisti-Seal panels also showed a greater resistance to corrosion, while also showing no signs of degradation during the Immersion Testing.

### Aged Painted Surface—Gloss Restoration and Retention

Testing on aged surfaces was undertaken in an effort to see the effects of Logisti-Seal on gloss restoration and protection of an aged, weathered surface. Logisti-Seal cannot restore color; however increases in gloss can significantly improve the appearance of an aged, weathered, faded surface. Due to the rapid deterioration of the aged, non-sealed panels and the absence of any ASTM testing procedures, the panels were subjected to 500 Hours of Accelerated Weathering.

The gloss testing was performed on 27-year-old aged panels from a commercial vehicle used in operations for 14 years and in a graveyard for 13 years in Galveston, Tex. The Galveston climate led to exposure to high levels of humidity and salt during both its operation and subsequent retirement. Three aged, non-sealed panels and three aged, Logisti-Sealed panels. Panels were tested prior and post 500 Hour Accelerated Weathering Testing at a 60 degree angle.

Application of Logisti-Seal to the aged panels increased gloss 688% when compared to the non-sealed, aged panels. After 500 Hours, the aged, Logisti-Sealed panels maintained their gloss 41% better than the aged, non-sealed panels.

### Laboratory Testing—Boeing Specifications

Sandwich Corrosion Testing, Acrylic Crazing Testing, Paint Softening, and Weight Change Testing were performed to individual specifications required by Boeing Document D6-17487 Revision P by Independent Total Inspection (ITI) Anti-Corrosion, Inc. ITI was selected based upon recommendations from airlines who had used their testing services before. All test specimens were hand delivered to ITI and prepared in their presence.

Sandwich Corrosion Testing was performed in general accordance with ASTM F1110 on both painted and unpainted aluminum panels. A programmable temperature/humidity chamber was used to conduct the testing. Pairs of 2″×4″ panels were used with a 1″×3″ test strip saturated with various test solutions. Results showed that after the prescribed exposure, no corrosion occurred.

Acrylic Crazing Testing was performed in accordance with ASTM F484 utilizing actual acrylic test specimens cut from a new window of a Boeing 737-800. These specimens were marginally thicker than the 0.25″ specified by ASTM F484; however the thickness difference was accounted for in the test loading to achieve a 4500-psi outer fiber bending stress on the specimens. The specimens were conditioned for 24 hours at 75 degrees Fahrenheit (plus/minus 5 degrees) and 50 percent relative humidity (plus/minus 5 percent) prior to testing. After the prescribed testing period, no crazing or other degradation was present.

Paint softening testing was performed in accordance with ASTM F502. The panels were treated with Logisti-Seal and then baked at 100 degrees Fahrenheit for 30 minutes, rinsed, and allowed to air dry for 24 hours. The samples were then evaluated and tested for hardness. No blistering, discoloration, cracking, crazing, or other degradation was found.

Weight Change Testing was performed by weighing a test panel, 151×68 mm, which had been wiped clean with a new, cotton cloth. The specimen was then treated with Logisti-Seal and reweighed The initial weigh was 60.5504 g and the weight after application was 60.5473 g, for a net loss of 0.0034 g.

Hydrogen Embrittlement testing was done to test for a number of forms of degradation of metals caused by exposure to environments (liquid or gas) which cause absorption of hydrogen into the material to cause degradation in the mechanical performance. This damage can be caused by formation of internal cracks, blisters, or voids in steel, loss of ductility, or a surface chemical reaction with hydrogen. The method used in this test was to test for mechanical hydrogen embrittlement for aircraft maintenance chemicals.

The testing was conducted on four specimens for 150 hours each. At the end of the testing, no failure had occurred on any specimen and a conformance result was issued by SMI, Inc.

### Operational Testing—Aviation

Operational test were performed to evaluate fuel savings, wash cycle, and appearance benefits of the sealing method of the present invention. A major airline operator was required in an effort to test Logisti-Seal in a true scheduled operating aviation environment, using a defined testing procedure to minimize as many variables as possible.

The sample of aircraft used to test the fuel savings benefits Logisti-Seal were 14 737-800 aircraft with winglets that were within 6 months of their delivery date to the fleet in order to minimize the bias of newer aircraft and/or engines. These aircraft were acknowledged as being the most reliable in terms of data and the “best fuel performers” within the fleet; therefore providing a higher confidence level and accuracy for the test. Two of the aircraft were treated with Logisti-Seal, two aircraft were waxed, and the other 10 aircraft were left untreated completely; the waxed and untreated aircraft serving as the control group.

The major component used to test the fuel savings performance of Logisti-Seal was the Boeing designed Aircraft Performance Monitoring (APM) Report. Monitoring the engines and airframe at stable cruise, the APM report allowed tracking of the fuel mileage of all aircraft within the test and control groups and a comparison of them to determine the effects of Logisti-Seal. It must be noted that this testing method focused only on the performance of Logisti-Seal at high altitude, stable cruise and does not include any benefits that could be achieved during ascent and descent. Benefits at stable cruise at high altitudes should only be amplified in thicker, denser air that is encountered in take-off and landing.

All aircraft in the sample were also reviewed during the 12-month test period for deviations in maintenance, stage length, weight (using qualitative temperature analysis to determine any passenger weight differentials), atmospheric conditions, and average vs. planned flight time records. Aircraft that deviated from the group norms for a given time period were excluded from testing data in order to ensure a filtered, statistically valid result.

The non-treated aircraft were kept on a 60-day wash cycle, while the two Logisti-Seal aircraft were switched to an “on condition” wash cycle. The difference in the wash cycles was to be measured by determining when the two treated aircraft would necessitate being washed. Using the testing method above, the following conclusions were drawn up for testing and analysis:
The fuel mileage improvement for the Logisti-Seal aircraft is statistically different from the control aircraft.
The average Logisti-Seal Fuel Mileage is 0.63% better than the control group.
The 95% Confident Interval shows a Logisti-Seal improvement of 0.41% to 0.85%.
Wash Cycle Extension from 60 Days to 240+ Days; Able to Remove Hydraulic Fluid with wet, cotton cloth.

Testing was also performed on aircraft to evaluate the corrosion protection, ease of clean, and paint protection of the method of the present invention. One aircraft was completely sealed with Logisti-Seal, while another aircraft was sealed only from the midline along the bottom of the aircraft up one side to the passenger windows. The two test aircraft were inspected and results showed that all test criteria had been met or exceeded. In addition to the operational testing, Logisti-Seal was applied to a clad 2024-T3 AMS-QQ-A-250/5 panel, which was tested against a non-sealed panel in a salt spray chamber.

In another test, Logisticlean applied Logisti-Seal to the spots on the cowlings of two aircraft in an effort to determine the increase in gloss on an aircraft that had been in service after the application of Logisti-Seal. The sections were chosen due to the fact that the all the colors in the paint schemes could be easily tested in these areas. Readings were taken pre and post application in the same spot. Readings were taken on two separate aircraft with both the new blue/red/yellow paint scheme and the old brown/red/white paint scheme. Both aircraft were 737's and the newer paint scheme was 4 years old, while the older paint scheme was 7 years old.

On the newer paint scheme, readings were taken for the blue, yellow and red sections of paint. Prior to application the blue section had a 13.8 gloss reading, the yellow section had 4.8-gloss reading, and the red section had a 3.1 gloss reading. Post application the blue section had 52.8-gloss reading, the yellow section had 47.7-gloss reading, and the red had 42.2-gloss reading. This represented increases in gloss percentages of 283% for the blue section, 894% for the yellow section, and 1261% for the red section.

On the older paint scheme, readings were taken for the brown, white and red sections of paint. Prior to application the brown section had a 36.5 gloss reading, the white section had 50.7-gloss reading, and the red section had a 3.8 gloss reading. Post application the brown section had 67.2-gloss reading, the white section had 68.9-gloss reading, and the red had 28.3-gloss reading. This represented increases in gloss percentages of 84% for the brown section, 36% for the white section, and 645% for the red section.

Operational test results in both aviation and ground equipment were analyzed to determine possible explanations for the performance of the processes of the present invention. Testing showed a decrease in drag; resulting in the decrease in fuel burn on the treated aircraft. The analysis resulted in two possible theories as to why the decrease in drag occurred. The first is that the application of Logisti-Seal smoothes the surface at the micron level, preventing the adherence of foreign debris. The second is that the application of Logisti-Seal is altering the surface-gas interaction; thus altering concepts relating to aerodynamic theory. In both cases, the result is a reduction in the amount of drag on the object to which Logisti-Seal is applied.

The method of the present invention was tested on both sealed and non-sealed panels. These panels were examined by Zygote Interferometer analysis software and Grazing Angle Illumination Photography Apparatus, to measure the effects of Logisti-Seal on a freshly painted surface in microns. The software analyzes the surface at levels of one and two microns in order to determine its true “roughness” and ability for particles and fluids to adhere at the nano-level. The photography allowed for pre and post roughness measurements with the application of Logisti-Seal. Upon completion of the roughness measurements, treated and untreated panels were tested in a low speed wind tunnel in order to determine flow properties at differing fluid velocities.

Sample image of the untreated panel showed little evidence of change after the blind treatment, while sample images of the panel with Logisti-Seal showed a much cleaner, smoother surface. The conclusion from the test results was that the “previously observed 0.63% fuel consumption reduction in flight is consistent with a reduction in borderline roughness heights. The reduction is most likely due to the Logisti-Prep and Logisti-Seal buffing portions of the application.”

The method of this invention provides significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention.

We claim:

1. A method for cleaning a hard surface at the micro level of the hard surface comprising the steps of:
applying a cleaning agent to a hard surface, the cleaning agent capable of penetrating the hard surface down to the microscopic level of the hard surface;
penetrating the hard surface down to the microscopic level by particles contained in the cleaning solution;
contacting and loosening dirt and debris located in crevasses at the microscopic level of the hard surface by the cleaning agent particles;
removing the cleaning agent and loosen dirt and debris from the hard surface; and
applying a sealing agent to the hard surface such that the sealing agent penetrates the hard surface down to the microscopic level of the hard surface and fills in crevasses in the hard surface from the microscopic level up to a top edge of the hard surface and such that the sealing agent adheres to the hard surface.

2. The method as described in claim 1 further comprising after said sealing agent applying step, the step of smoothing any excess sealing agent from the hard surface to further improve aero-dynamic efficiency of the hard surface.

3. The method as described in claim 2 wherein in said adhering of the sealing agent to the hard surface further comprises bonding of the sealing agent to the hard surface from the microscopic level up to the top edge of the hard surface.

4. The method as described in claim 3 further comprising after said sealing agent applying step, the step of curing the sealing agent by allowing a predetermined amount time between said sealing agent applying step and said smoothing step.

5. The method as described in claim 1 wherein the microscopic level comprises a 10 by 10 nanometer segment.

6. The method as described in claim 1 wherein the applied cleaning agent has the attributes of bring non-abrasive and highly absorbent.

7. The method as described in claim 6 wherein the applied cleaning agent comprises granule particles having microscopic sizes that enable the granule particles to fall into and penetrate microscopic crevasses in the hard surface.

8. The method as described in claim 7 wherein said cleaning agent applying step further comprises applying the cleaning agent to the hard surface with a cotton material.

9. The method as described in claim 1 further comprising after said cleaning agent removing step, repeating said cleaning agent applying step, said contacting step, and said cleaning agent removing step.

10. The method as described in claim 7 wherein said contacting step further comprises the steps of:
attracting dirt and debris in microscopic crevasses of the hard surface by the granule particles in the cleaning agent; and
drawing dirt and debris from the hard surface and to the granule particles through absorption attributes of the granule particles.

11. The method as described in claim 1 wherein said cleaning agent removing step further comprises removing the cleaning agent to the hard surface with a cotton material such that absorption attributes of the cotton material creates a suction to more efficiently remove the cleaning agent and dirt and debris from the hard surface.

12. The method as described in claim 1 wherein said sealing agent has the attributes of consistent with the characteristics of molecules in the acrylic polymer family.

13. The method as described in step 3 wherein said bonding step further comprises the steps of penetrating the hard surface down to the microscopic level by microscopic granules in the sealing agent and adhering to the walls to the hard surface crevasses by the microscopic particles in the sealing agent.

14. A method for cleaning a hard surface of an air-flying vehicle at the micro level of the hard surface of the vehicle comprising the steps of:
applying a cleaning agent to a hard surface, the cleaning agent capable of penetrating the hard surface down to the microscopic level of the hard surface;
penetrating the hard surface down to the microscopic level by particles contained in the cleaning solution;
contacting and loosening dirt and debris located in crevasses at the microscopic level of the hard surface by the cleaning agent particles;
removing the cleaning agent and loosen dirt and debris from the hard surface; and
applying a sealing agent to the hard surface such that the sealing agent penetrates the hard surface down to the microscopic level of the hard surface and fills in crevasses in the hard surface from the microscopic level up to a top edge of the hard surface and such that the sealing agent adheres to the hard surface and provides improve aero-dynamic efficiency of the hard surface.

15. The method as described in claim 14 further comprising after said sealing agent applying step, the step of smoothing any excess sealing agent from the hard surface to further improve aero-dynamic efficiency of the hard surface.

16. The method as described in claim 15 wherein in said sealing agent applying furthering comprises bonding of the sealing agent to the hard surface at the microscopic level.

17. The method as described in claim 16 further comprising after said sealing agent applying step, the step of curing the sealing agent by allowing a predetermined amount time between said sealing agent applying step and said smoothing step.

18. The method as described in claim 14 wherein said cleaning agent removing step further comprises removing the cleaning agent to the hard surface with a cotton material such that absorption attributes of the cotton material creates a suction to more efficiently remove the cleaning agent and dirt and debris from the hard surface.

19. The method as described in claim 14 wherein said contacting step further comprises the steps of:
attracting dirt and debris in microscopic crevasses of the hard surface by microscopic granule particles in the cleaning agent; and
drawing dirt and debris from the hard surface and to the granule particles through absorption attributes of the granule particles.
